(19) United States
(12) Patent Application Publication
(10) Pub. No.: US 2021/0086091 A1
(43) Pub. Date: Mar. 25, 2021

(54) Pacifier Plush Toy Accessory

(71) Applicant: Doodalou LLC, Allen, TX (US)

(72) Inventor: Amanda Jackson, Allen, TX (US)

(21) Appl. No.: 17/027,892

(22) Filed: Sep. 22, 2020

Related U.S. Application Data
(60) Provisional application No. 62/904,343, filed on Sep. 23, 2019.

(51) Int. Cl. A63H 3/52; A63H 3/02; A61J 17/00

(52) U.S. Cl. CPC A63H 3/52; A61J 17/1111; A63H 3/02

(57) ABSTRACT

The invention relates to garments for pacifier plush toy accessories which are detachably configured to attach and detach from a plush toy attached to a pacifier or another pacifier accessory. The invention includes a decorative garment, which is attached to a plush pacifier toy, with multiple designs or fabric prints which includes an attachment means, such as hook and loop material, that is attached in place on the garment and which allows the garment to be easily attached or detached from a pacifier plush toy, another pacifier accessory or plush toy. The garment may encompass a wide variety of styles and shapes, such as a fireman jacket, a police uniform, dresses, jeans, hoodies, sports uniforms, overalls, coveralls, jumpers, cheerleader uniforms, band uniforms, lab coats, professional uniforms, sports uniforms, jerseys, tutus, skirts and any other garment type.

### CROSS-REFERENCE TO RELATED APPLICATIONS

This application claims the benefit of U.S. Provisional Patent Application Ser. No. 62/904,343 filed Sep. 23, 2019, and entitled “Pacifier Plush Toy Accessory”, which is incorporated herein by referenced in its entirety.

### BACKGROUND OF THE INVENTION

The present invention relates to a garment, and more particularly, garments for plush toy accessories which are attached to a child's pacifier.

Traditionally, pacifiers have been used to soothe infants and small children. Most pacifiers are designed with various considerations including proper dental and jaw development. However, most current pacifier designs do not provide any ornamentation or other decorative features other than ornamental script or artwork applied to the pacifier faceplate or pacifier ring. The attachment of a plush toy to a pacifier is a recent trend and there is a need for garments that can be dressed on, adapted and fitted to a variety of plush toy accessories that are adapted for use with a pacifier. Furthermore, there is a need for plush toy garments made of materials suitable as to appearance for plush toy clothing and that are easily dressed and removed from various plush toy accessories.

### SUMMARY OF INVENTION

The invention relates to garments for pacifier plush toy accessories which are detachably configured to attach and detach from a pacifier. The invention includes a decorative garment, which is attached to a plush pacifier toy, with multiple designs or fabric prints comprising or imprinted on the garment which includes fastening means, such as hook and loop material, attached to the garment and which allows the garment to be easily attached or detached from a pacifier plush toy, another pacifier accessory or plush toy.

The garments may encompass a wide variety of styles and shapes, such as a fireman jacket, a police uniform, dresses, jeans, hoodies, sports uniforms, overalls, coveralls, jumpers, cheerleader uniforms, band uniforms, lab coats, professional uniforms, sports uniforms, jersey, tutus, skirts and any other garment type. The garments are interchangeable and may be designed with the ability to be easily attached, removed and re-attached to various pacifier designs, various pacifier accessories, plush toys or other toys and dolls with ease. The garments also serve to protect the plush toy accessory from water, liquid or other stain causing material from being deposited or splashed on the plush accessory.

### BRIEF DESCRIPTION OF THE DRAWINGS

The present invention will be more readily understood from the following detailed description, read in conjunction with the accompanying drawings, in which:

FIG. 1 is a perspective view of a garment embodying the features of the present invention;

FIG. 2 is a front view of a garment embodying the features of the present invention;

FIG. 3A is a rear view of a garment embodying the features of the present invention;

FIG. 3B is a rear view of a garment completely opened embodying the features of the present invention;

FIG. 4 is a side view of a garment embodying the features of the present invention;

FIG. 5 is a top view of a garment embodying the features of the present invention;

FIG. 6 is a bottom view of a garment embodying the features of the present invention; and,

FIG. 7 is a front view depicting the garment embodying the features of the present invention attached to a plush toy.

### DETAILED DESCRIPTION

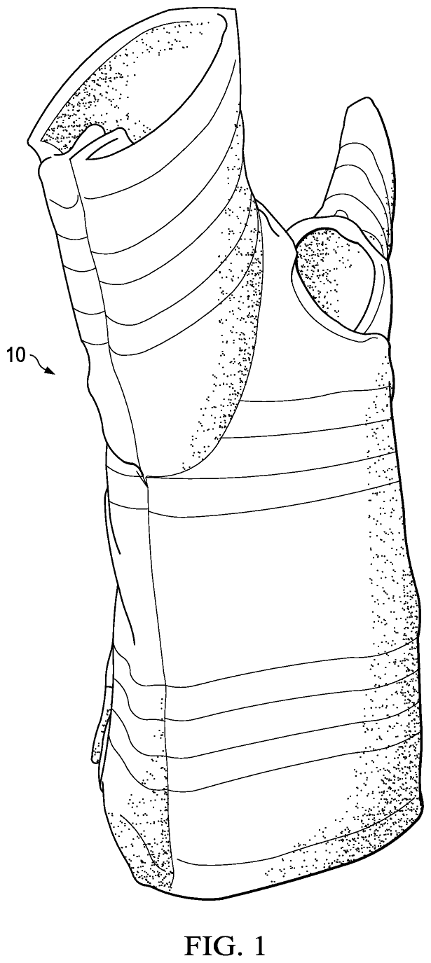

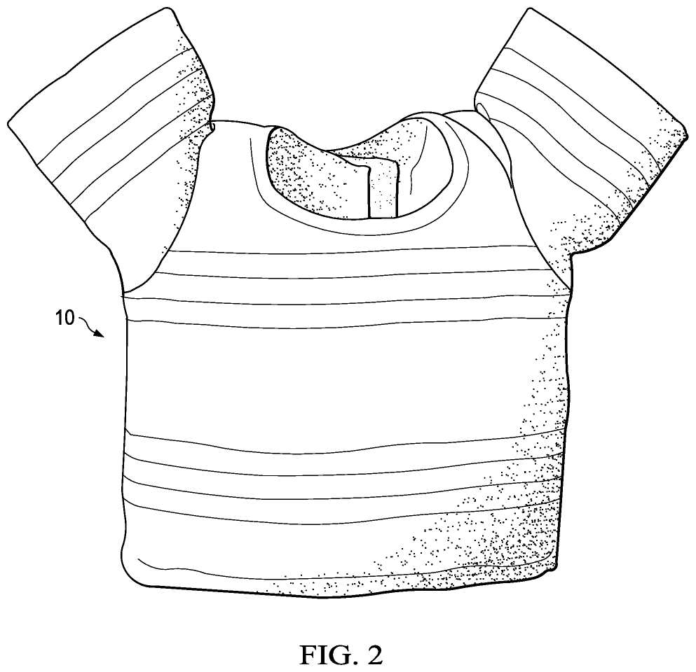

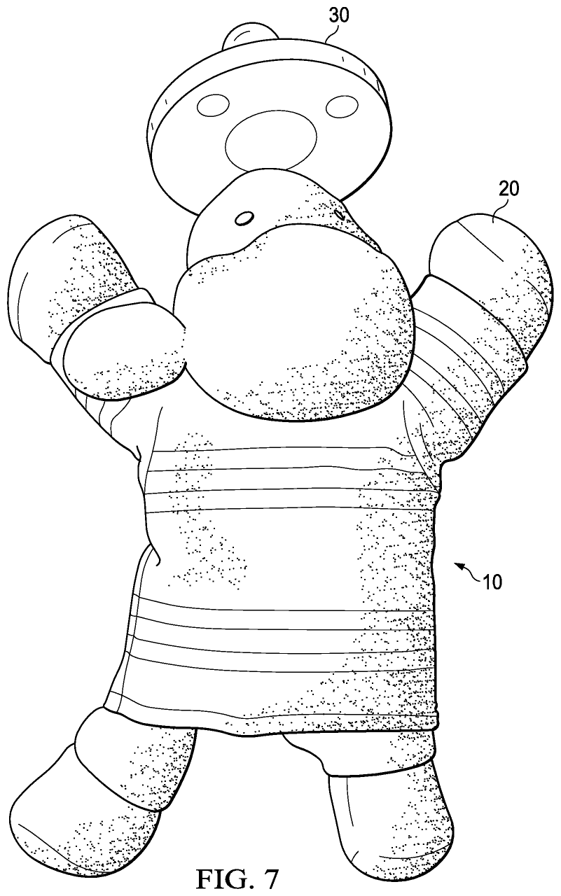

Referring to FIGS. 1 and 2, a garment 10, which for illustrative purposes, can be considered as a fireman jacket is shown. It is to be understood that any style or design of the garment 10 may embody the principles of the invention disclosed herein and the scope of the invention is not to be limited to a particular style or design imprinted or otherwise shown on any surface of the invention disclosed herein. The garment 10 is designed and manufactured to the general dimensions associated with a variety of plush toy designs, such as plush toy 20 (shown in FIG. 7), which may be detachably attached to a pacifier 30 (as depicted in FIG. 7) or any other pacifier accessory, toy or doll to which the garment 10 may be attached.

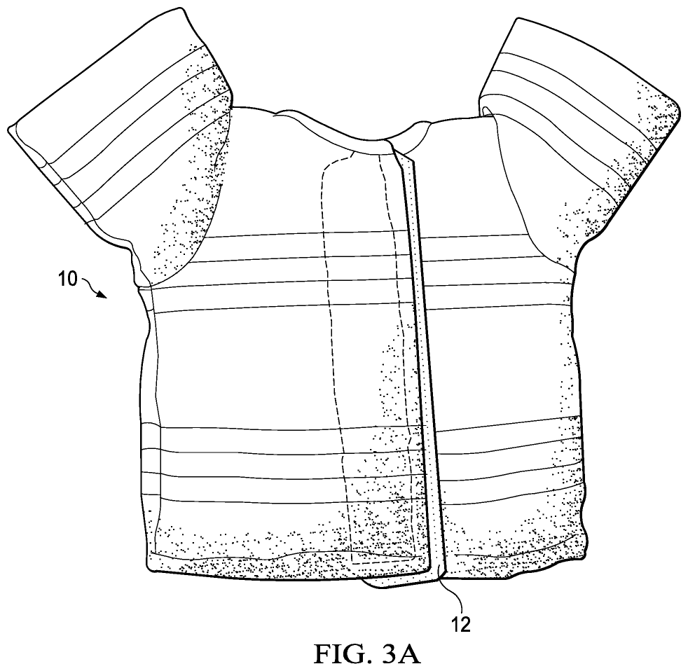

Turning to FIGS. 3A AND 3B, the garment 10 is shown in a closed and open position. In the depicted embodiment, garment 10 includes a fastening means, such as hook and loop fasteners 12 as depicted in FIG. 3B, which are fastened to garment 10 and provide for the ability to attach and remove garment 10 from the plush toy 20. Hook and loop fasteners 12 may be stitched or glued to garment 10 in strips or patches or otherwise attached to garment 10 as is known in the art. Likewise, additional fastening means such as buttons, snaps, hook and eyelets, and other appropriate fastening systems may also be used as appropriate. Garment 10 may be manufactured from any variety of fabrics or substrates as are known in the art, such as cotton, nylon, polyester, rayon or other materials suitable for the purpose.

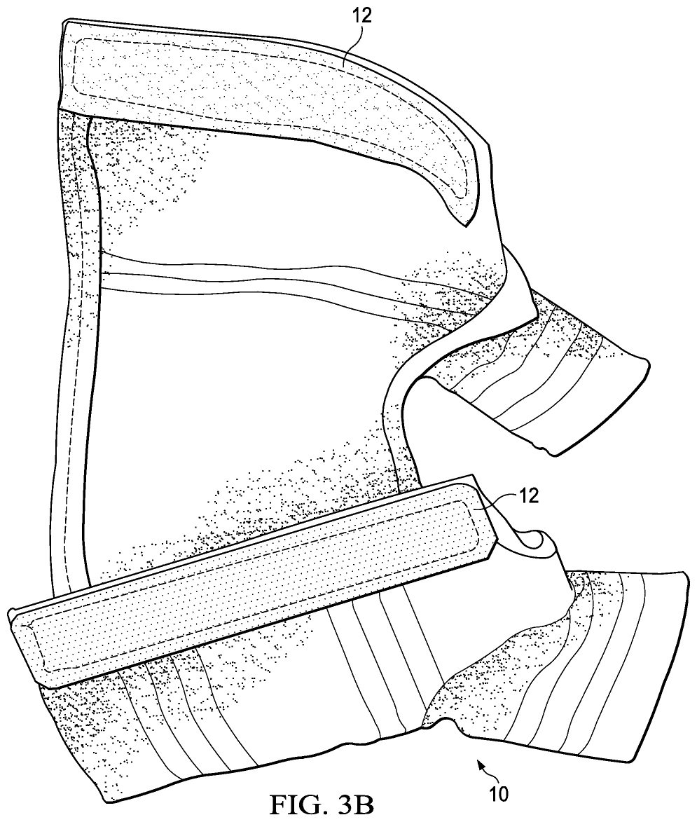

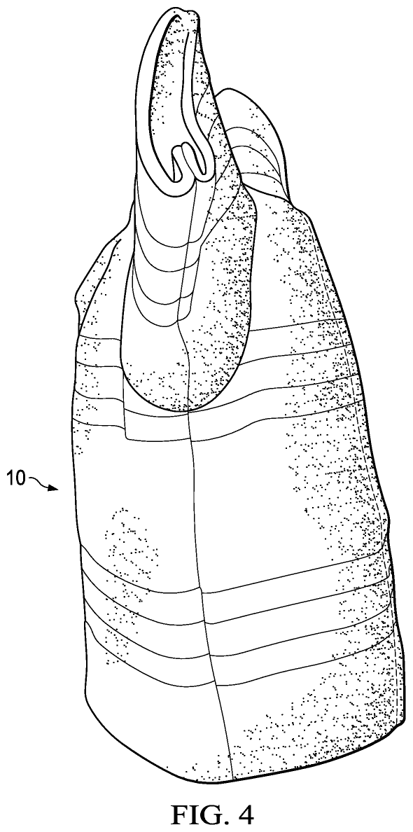

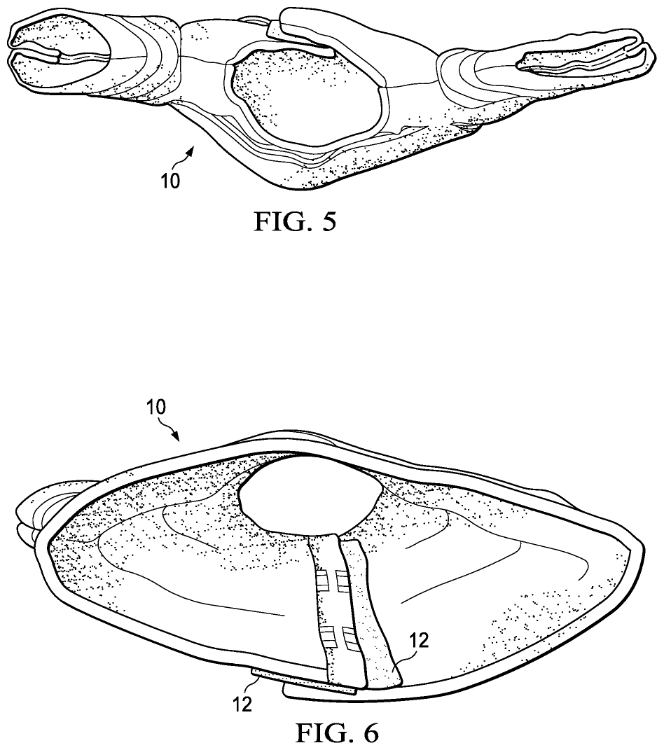

FIGS. 4 and 5 are side and top view depictions of garment 10 showing the garment 10 in a closed position. FIG. 6 is a bottom view showing garment 10 in a closed position and reflecting the fastened state of hook and loop fasteners 12 when mated together.

Turning to FIG. 7, garment 10 is shown attached to plush toy 20 which is shown attached to pacifier 30. In alternative embodiments, garment 10 may include different garment designs, such as a police officer uniform, a cheerleader uniform, a sports uniform, a nurse uniform, a sports jersey, a swimsuit, a tuxedo, a wedding dress, a tutu, a skirt or a military style uniform. Garment 10 may also be fashioned and styled for other pacifier accessories or different styles of plush toys, such as dogs, cats, giraffes, elephants, lions, tigers, fish, rabbits, lambs, sloths and other animal shape plush toys, human shape plush toys or any shape plush toy. In attaching garment 10 to plush toy 20, hook and loop fasteners 12 are separated which opens up the back of garment 10. Garment 10 is fastened around a portion of plush toy 20 by mating the hook and loop fastener 12 together. To remove garment 10 from plush toy 20, the user simply separates hook and loop fastener 12 and pulls garment 10 away from plush toy 20.

When dressed on plush toy 20, garment 10 also acts to protect plush toy 20 from water, liquid or other stain causing agents when any such materials are deposited on garment 10. Garment 10 may be manufactured from materials which are machine and/or hand washable or which may be dry cleaned. Garment 10 may also be treated with fabric protectants such as SCOTCHGUARD which further assist in repelling liquids, spills and stain causing agents.

In an embodiment, a method of practicing the invention includes a garment 10 with one or more fastening means 12 secured to the garment 10. Fastening means 12 are separated and the garment 10 is dressed on plush toy 20. Fastening means 12 is then mated together to secure garment 10 to plush accessory 20. Plush accessory 20 is then attached to pacifier 30. If garment 10 becomes stained or dirty after use, fastening means 20 is separated and garment 10 is removed from plush accessory 20 for cleaning and reuse as desired.

It is to be understood the implementations are not limited to particular systems or processes described which may, of course, vary. It is also to be understood that the terminology used herein is for the purpose of describing particular implementations only and is not intended to be limiting. As used in this specification, the singular forms “a”, “an” and “the” include plural references unless the content clearly indicates otherwise.

Although the present disclosure has been described in detail, it should be understood that various changes, substitutions and alterations may be made herein without departing from the spirit and scope of the disclosure.

I claim:

1. A garment for a plush toy, comprising:
a garment sized and shaped to the approximate size and shape of at least a portion of a plush toy, wherein the garment includes fastening means to provide for application and removal of the garment from a portion of the plush toy.

2. The garment of claim 1, wherein the fastening means comprises one selected from the following group:
a) hook and loop material;
b) snaps;
c) buttons; and,
d) hook and eyelet.

3. The garment of claim 1 wherein the garment is dressed on the plush accessory and the plush accessory is attached to a pacifier.

4. The garment of claim 1 wherein the garment further includes a design feature comprising one of multiple styles and shapes, such as a fireman jacket, a police uniform, a dress, a jean, a hoodie, a sport uniform, an overall, a coverall, a jumper, a cheerleader uniform, a band uniform, a lab coat, a professional uniform, a jersey, a nurse uniform, a swimsuit, a tuxedo, a wedding dress, a tutu, a skirt or a military style uniform.

5. The garment of claim 1 wherein the garment is fashioned and styled for use with various styles of plush toys comprising a dog, a cat, a giraffe, an elephant, a lion, a tiger, a fish, a rabbit, a lamb, a sloth or a human shape plush toy.

6. A method for attaching a garment to a plush toy, the method comprising:
providing a garment sized and shaped to the approximate size and shape of at least a portion of plush toy;
providing fastening means to provide for application to and removal of the garment from a portion of the plush toy.

7. The method of claim 6, wherein the plush toy is attached to a pacifier.

8. The method according claim 6, wherein the garment includes a design feature comprising one of multiple styles and shapes, such as a fireman jacket, a police uniform, a dress, a jean, a hoodie, a sport uniform, an overall, a coverall, a jumper, a cheerleader uniform, a band uniform, a lab coat, a professional uniform, a jersey, a nurse uniform, a swimsuit, a tuxedo, a wedding dress, a tutu, a skirt or a military style uniform.

9. The method of claim 6, wherein the plush toy design is one selected from the group comprising a dog, a cat, a giraffe, an elephant, a lion, a tiger, a fish, a rabbit, a lamb, a sloth or a human shape plush toy.

10. The method of claim 6, wherein the fastening means comprises one selected from the group comprising hook and loop, snaps, buttons, hook and eyelet.
